(19) United States
(12) Patent Application Publication
(10) Pub. No.: US 2012/0276945 A1
(43) Pub. Date: Nov. 1, 2012

(54) CELL SELECTION TECHNIQUES FOR IDLE MODE FOR WIRELESS NETWORKS

(75) Inventors: Aik Chindapol, Washington, DC (US); Giovanni Maggi, Milano (IT); Daniele Tortora, Milano (IT)

(73) Assignee: NOKIA SIEMENS NETWORKS OY, ESPOO (FI)

(21) Appl. No.: 13/094,228

(22) Filed: Apr. 26, 2011

(51) Int. Cl. H04W 72/02; H04W 36/30

(52) U.S. Cl. 455/525

(57) ABSTRACT

Various example embodiments are disclosed herein. According to an example embodiment, an apparatus may include a processor. The processor may be configured to: make a first determination, by a mobile station in idle mode, that a trigger condition for cell selection has been met for a target base station as compared to a current preferred base station; compare a network specified cell preference of the target base station to a network specified cell preference of the current preferred base station; select the target base station as a new preferred base station if the cell preference of the target base station is the same or lower than the cell preference of the current preferred base station; otherwise, if the cell preference of the target base station is higher than the cell preference of the current preferred base station, then selecting the target base station as a new preferred base station only if the trigger condition for cell selection for the target base station is still met after a delay period after the first determination has been made.

### PRIORITY CLAIM

This application is a national stage entry of PCT Application No. PCT/EP2009/062994 filed on Oct. 7, 2009, entitled “Cell Selection Techniques For Idle Mode For Wireless Networks”, which, in turn, claims the benefit of priority based on U.S. Provisional Application No. 61/110,540, filed on Oct. 31, 2008, entitled “Cell Selection Techniques For Idle Mode For Wireless Networks”, the disclosures of which are hereby incorporated by reference in their entirety.

### TECHNICAL FIELD

This description relates to wireless networks.

### BACKGROUND

Some wireless networks may support both mobile station (MS) initiated handover and base station (BS) initiated handover. Different handover algorithms and/or criteria may be used by a MS and a BS, for example, for handover. In some cases, for example, a MS may initiate handover based on received channel quality or RSSI (received signal strength indication), e.g., performing handover to a BS having highest channel quality as received by the MS. Whereas, the BS typically has a wider scope, the BS may instruct the MS to handover to a BS to perform load balancing or reduce load on the BS, for example. In some cases, a ping-pong effect can occur where a BS may instruct the MS to handover to a target BS that is not the best serving BS (from the MS's perspective), only to have the MS perform a handover back to the best serving BS.

In addition, in some wireless networks, a MS may enter an Idle mode to conserve power. Cell selection or reselection may be performed by a MS in idle mode.

### SUMMARY

According to an example embodiment, a method may include making a first determination, by a mobile station in idle mode, that a trigger condition for cell selection has been met for one or more target base stations as compared to a current preferred base station, each of the one or more target base stations having a network specified cell preference, and selecting one of the one or more target base stations as a new preferred base station for idle mode based on the network specified cell preferences for the one or more target base stations.

According to another example embodiment, an apparatus may include a processor. The processor may be configured to: make a first determination, by a mobile station in idle mode, that a trigger condition for cell selection has been met for one or more target base stations as compared to a current preferred base station, each of the one or more target base stations having a network specified cell preference; and select one of the one or more target base stations as a new preferred base station for idle mode based on the network specified cell preferences for the one or more target base stations.

In another example embodiment, a method may include making a first determination, by a mobile station in idle mode, that a trigger condition for cell selection has been met for one or more candidate base stations as compared to a current preferred base station, the current preferred base station and each of the one or more candidate base stations having a network specified cell preference, selecting one of the one or more candidate base stations as a target base station based on the network specified cell preferences for the one or more candidate stations, comparing a cell preference of the target base station to a cell preference of the current preferred base station, and, if the cell preference of the target base station is higher than the cell preference of the current preferred base station, then selecting the target base station as a new preferred base station for idle mode only if the trigger condition for cell selection for the target base station is still met after a delay period after the first determination has been made.

According to another example embodiment, an apparatus may include a processor. The processor may be configured to: make a first determination, by a mobile station in idle mode, that a trigger condition for cell selection has been met for one or more candidate base stations as compared to a current preferred base station, the current preferred base station and each of the one or more candidate base stations having a network specified cell preference; select one of the one or more candidate base stations as a target base station based on the network specified cell preferences for the one or more candidate stations; compare a cell preference of the target base station to a cell preference of the current preferred base station; and if the cell preference of the target base station is higher than the cell preference of the current preferred base station, then selecting the target base station as a new preferred base station for idle mode only if the trigger condition for cell selection for the target base station is still met after a delay period after the first determination has been made.

In another example embodiment, a method may include making a first determination, by a mobile station in idle mode, that a trigger condition for cell selection has been met for a target base station as compared to a current preferred base station, comparing a cell priority of the target base station to a cell priority of the current preferred base station, selecting the target base station as a new preferred base station if the cell priority of the target base station is the same or lower than the cell priority of the current preferred base station, otherwise, if the cell priority of the target base station is higher than the cell priority of the current preferred base station, then selecting the target base station as a new preferred base station only if the trigger condition for cell selection for the target base station is still met after a delay period after the first determination has been made.

According to another example embodiment, an apparatus may include a processor. The processor may be configured to: make a first determination, by a mobile station in idle mode, that a trigger condition for cell selection has been met for a target base station as compared to a current preferred base station; compare a cell priority of the target base station to a cell priority of the current preferred base station; select the target base station as a new preferred base station if the cell priority of the target base station is the same or lower than the cell priority of the current preferred base station; and, otherwise, if the cell priority of the target base station is higher than the cell priority of the current preferred base station, then selecting the target base station as a new preferred base station only if the trigger condition for cell selection for the target base station is still met after a delay period after the first determination has been made.

According to yet another example embodiment, a method may include making a first determination, by a mobile station in idle mode, that a trigger condition for cell selection has been met for a target base station as compared to a current preferred base station, comparing a network specified cell preference of the target base station to a network specified cell preference of the current preferred base station, selecting the target base station as a new preferred base station if the cell preference of the target base station is the same or lower than the cell preference of the current preferred base station, and, otherwise, if the cell preference of the target base station is higher than the cell preference of the current preferred base station, then selecting the target base station as a new preferred base station only if the trigger condition for cell selection for the target base station is still met after a delay period after the first determination has been made.

According to another example embodiment, an apparatus may include a processor. The processor may be configured to: make a first determination, by a mobile station in idle mode, that a trigger condition for cell selection has been met for a target base station as compared to a current preferred base station; compare a network specified cell preference of the target base station to a network specified cell preference of the current preferred base station; select the target base station as a new preferred base station if the cell preference of the target base station is the same or lower than the cell preference of the current preferred base station; otherwise, if the cell preference of the target base station is higher than the cell preference of the current preferred base station, then selecting the target base station as a new preferred base station only if the trigger condition for cell selection for the target base station is still met after a delay period after the first determination has been made.

According to another example embodiment, a method may include determining, at a mobile station in idle mode, a channel quality of a current preferred BS and a channel quality of a candidate base station; making a determination that the channel quality of the candidate base station is greater than a sum of the channel quality of the current preferred BS and an idle mode hysteresis margin; and adding, based on the determination, the candidate base station to a list of possible target base stations to be monitored for a trigger condition.

The details of one or more implementations are set forth in the accompanying drawings and the description below. Other features will be apparent from the description and drawings, and from the claims.

### BRIEF DESCRIPTION OF THE DRAWINGS

FIG. 1A is a block diagram of a wireless network according to an example embodiment.

FIG. 1B is a block diagram of a hierarchical cell structure or layered network according to an example embodiment.

FIG. 2 is a diagram illustrating an example embodiment of a frame that may be used according to an example embodiment.

FIG. 3 is a flow chart illustrating operation of a mobile station according to an example embodiment.

FIG. 4 is a flow chart illustrating operation of a mobile station according to an example embodiment.

FIG. 5 is a flow chart illustrating operation of a mobile station according to an example embodiment.

FIG. 6 is a flow chart illustrating operation of a mobile station according to another example embodiment.

FIG. 7 is a block diagram of a wireless node according to an example embodiment.

FIG. 8 is a flow chart illustrating operation of a mobile station according to another example embodiment.

### DETAILED DESCRIPTION

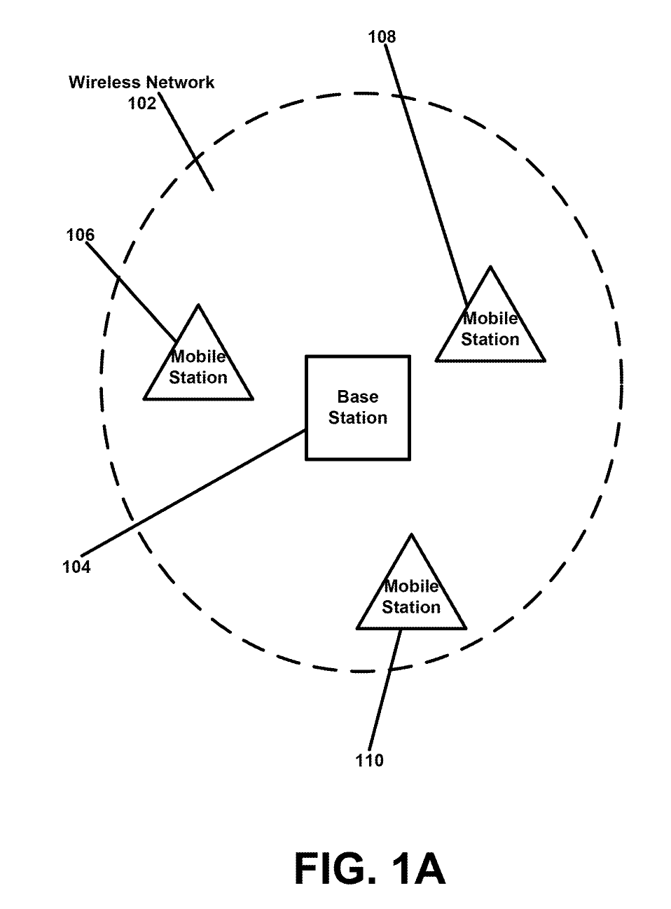

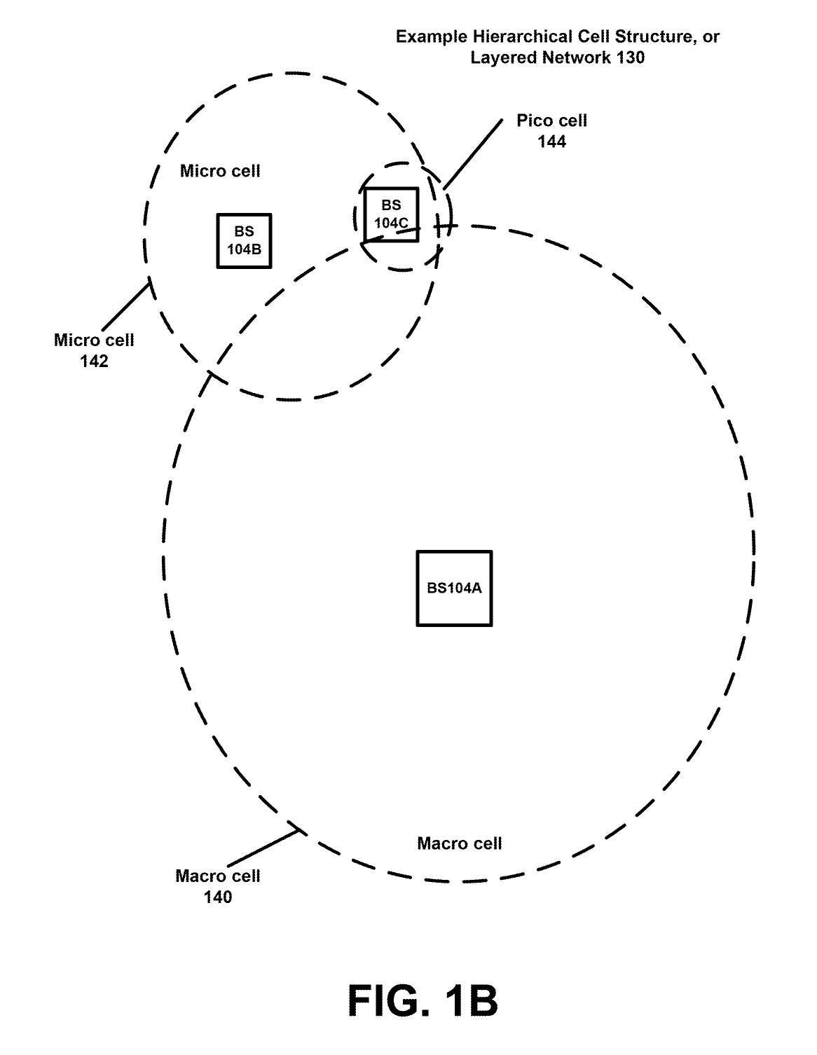

FIG. 1A is a block diagram of a wireless network 102 including a base station 104 and three mobile stations 106, 108, 110 according to an example embodiment. Although not shown, mobile stations 106, 108 and 110 may be coupled to base station 104 via relay stations or relay nodes, for example. The wireless network 102 may include, for example, an IEEE 802.16 Wireless Metropolitan Area Network (WiMAX), an IEEE 802.11 Wireless Local Area Network (WLAN), or a cellular telephone network, according to example embodiments. The base station 104 may include a cellular or WiMAX base station (BS), a node B, an 802.11 access point, or other infrastructure node, according to various example embodiments. The term “base station” (BS) may be used herein and may include any type of infrastructure node. The mobile stations 106, 108, 110 may include laptop or notebook computers, smartphones, personal digital assistants (PDAs), cellular telephones, WiMAX device, subscriber station, or any other wireless device, according to example embodiments. The term “wireless node” may include any type of wireless node, such as base stations, mobile stations, etc. While the present disclosure may use some of the terminology of WiMAX or other wireless standards, aspects of the present disclosure may be applicable to any networking or wireless technologies.

FIG. 1B is a block diagram of a hierarchical cell structure or layered network according to an example embodiment. According to an example embodiment, a hierarchical cell structure or layered network may include cells of different types or sizes that overlap with each other. For example, the layered network 130 in FIG. 1B may include multiple cells or networks, such as a macro cell 140, a micro cell 142 and a pico cell 144. Base stations (or other infrastructure node) may be provided for each cell, including BS 104A for macro cell 140, BS 104B for micro cell 142, and BS 104C for pico cell 144. Relatively speaking, macro cell 142 may be the largest of the three types of cells, and the pico cell 144 may be the smallest of the three cell types, with micro cell having a size that may be between the sizes of the macro and pico cells, according to an example embodiment. This is merely one example embodiment of a layered or hierarchical network or cell structure, and the various embodiments are not limited thereto.

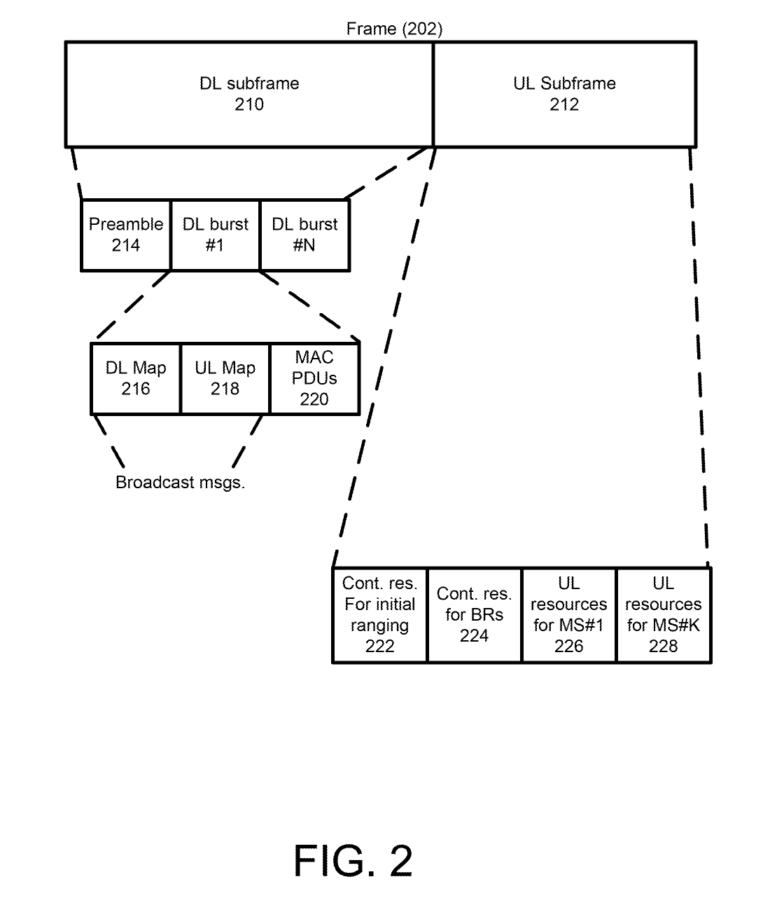

FIG. 2 is a diagram illustrating a frame according to an example embodiment. Although the frame in FIG. 2 may, as an example, be provided in a TDD (time division duplex) format, the various embodiments described herein may be applied to a wide variety of frame formats, such as a FDD (frequency division duplex) frame, for example. Thus, the frame format or duplexing arrangement shown in the example of FIG. 2 is not limiting with respect to embodiments described herein. The example frame 202 may include a downlink (DL) subframe 210 and an uplink (UL) subframe). The DL direction may include signals transmitted from the BS 104 to mobile stations (or mobile nodes) 106, 108 and 110. While the UL direction may include signals transmitted from mobile stations 106, 108 or 110 to BS 104.

The DL subframe 210 illustrated in FIG. 2 is an example DL subframe, and may include a number of fields, some of which are shown in FIG. 2. The DL subframe 210 may include a preamble 214, and one or more DL data bursts, such as DL burst #1, DL burst #2, . . . DL burst #N. DL burst #1 may include a Map message that may include some scheduling information for one or more data bursts. DL burst #1 may include a DL Map 216 that provides DL burst scheduling information, and an UL Map 218 that may provide UL scheduling information (or identify the scheduled UL resources for the current subframe or for a subsequent subframe). The DL Map 216 and the UL Map 218 are part of the broadcast information or broadcast messages transmitted by BS 104, for example. A Map message, transmitted by a BS 104 (FIG. 1) to one or more mobile stations, may include the DL Map 216, the UL Map 218, and/or other information, to provide scheduling and resource information for DL and UL transmissions. The DL Map 216 and the UL Map 218 may be transmitted via one or more information elements (IEs) within a Map message, for example. For example, each Map IE may allocate resources to a MS or connection ID (CID), e.g., by specifying the allocated resources and the CID or MS for which the resources are allocated. Additional MAC PDUs 220 (protocol data units) may also be provided in the DL subframe 210.

UL subframe 212 illustrates some fields of an example UL subframe, and may include, for example, UL contention resources for initial ranging 222, UL contention resources for bandwidth requests 224 (e.g., to allow MSs to make requests for bandwidth or UL resources), and then UL resources allocated to one or more mobile stations, .e.g., UL resources for MS#1 226, . . . UL resources for MS#K 228. Other fields may be provided in DL subframe 210 and/or UL subframe 212. Frame 202 is merely an example frame format, and a wide variety of frame formats may be used.

According to an example embodiment, a mobile station (MS) may transition to an idle mode in order to save battery power. While in idle mode, a MS may camp on a preferred BS (or receive signals from the preferred BS, and check for paging messages from the preferred BS). While in idle mode, the MS may, for example, operate in a MS paging listening interval or a MS paging unavailable interval.

During a MS paging listening interval of idle mode, the MS may receive and decode a DL-MAP (downlink Map) from the preferred BS to obtain the location of, and then receive, the broadcast paging messages. The broadcast paging messages may indicate whether the preferred BS has data to be delivered to the MS. If the paging message(s) indicate data to be delivered to the MS, the MS may then transition from idle mode to active mode, perform network re-entry with the preferred BS and then receive the data. Network entry or network re-entry may include performing ranging with the BS (e.g., to obtain parameters from the BS), capabilities exchange between the MS and BS, authentication with the BS, and registration with the BS, for example. At the end of MS paging listening interval, the MS may return to the MS paging unavailable interval of idle mode.

During a MS paging unavailable interval of idle mode, the MS may power down a portion of the MS circuitry, may scan neighbor BSs (e.g., receive signals of neighbor BSs, and measure channel quality, or RSSI or CINR of the received signals), may perform cell selection/reselection for idle mode (e.g., select a new preferred BS for idle mode), perform ranging or other activities. Cell selection may also be referred to as cell reselection since the MS is selecting a new preferred BS (replacing the current preferred BS with the new preferred BS). In an example embodiment, a MS may perform cell selection or reselection in order to obtain a new preferred BS for idle mode. Cell selection may be performed based on a number of criteria or measurements, such as, for example, downlink channel quality (or quality of air interface DL properties) which may include RSSI (received signal strength indication), CINR (carrier to interference and noise ratio), cell preference (e.g., which may include or may be based on cell type, cell priority, cell size, cell utilization/cell load/available resources for each cell, . . . ), and other criteria or information.

In some cases, a MS may choose any (or almost any) BS as part of cell selection/reselection in idle mode, with little or no guidance or input from the network. However, the network (e.g., a BS, a network controller, network entity, mobile switching center) may attempt to balance the load among different BSs. Given different implementation possibilities, the MS, in some cases, may select any BS as a new preferred BS while in idle mode, which may undermine efforts by the network to balance load among the multiple BSs. Thus, in that case, for example, when the MS transitions to active mode, the BS may request (or force) the MS to perform a handover to a second BS to balance the load among multiple cells or BSs, for example. This may introduce unnecessary overhead or inefficiencies, as it may be more efficient to have the MS select a BS as a new preferred BS in idle mode that would accomplish the load balancing or other network objective.

According to an example embodiment, one or more mechanisms are provided to guide (or at least partially control) the MS's cell selection in idle mode.

According to an example embodiment, a network cell preference may be assigned to each cell or base station (BS). This cell preference information may be used by a MS in determining which target base station to select as a new preferred BS, for example. A network entity (e.g., a MSC, network controller, handover controller or other entity or controller, or even a BS) may assign a cell preference to each of one or more base stations. Then, a BS may transmit or broadcast the one or more cell preference(s) for each of a plurality of BSs, as well as broadcasting cell preference(s) for itself. For example, a BS may broadcast network specified cell preference information for the transmitting BS/cell, and for one or more neighbor BSs/cells.

Cell preference may include different types of information, according to different example embodiments. For example, cell preference may include: a cell type (e.g., macro cell, micro cell, pico cell); a cell size (e.g., large cell, medium cell, and small cell); cell priority (e.g., high, medium or low priority); a cell subscriber group; a cell utilization/cell load or indication of available resources at each BS (e.g., a numerical value indicating an amount or percentage of cell usage, or an amount or percentage of available resources at a cell), or other preference information.

For example, in a layered network scenario comprising macro cells, micro cells, and pico cells, the smaller cells might be assigned higher priority values with the aim of encouraging selection of those cells as a new preferred BS in idle mode when the MS is within their coverage area. This may leave more resources available in larger cells (e.g., macro cells) that may be used for fast moving MSs. Also, the smaller cells may be desirable since they may typically use lower power for transmissions, which may create less cell interference as compared to larger cells (e.g., macro cells). Thus, for example, a macro cell may be assigned a low priority (e.g., a value of 3), a micro cell may be assigned a medium priority (e.g., 2), and a pico cell may be assigned a high priority (e.g., 1). For example, a MS may select a target base station that is within range (e.g., received channel quality above a threshold, or a received DL channel quality of the target that is greater than the received DL channel quality from the current preferred BS), which has the highest priority. Or, a MS may select a target BS to be a new preferred BS that allows access to a same cell subscriber group as the current preferred BS, for example.

Alternatively, a MS in idle mode may select a BS to be a new preferred BS based on cell size for each of the BSs within range. For example, a higher preference may be applied to smaller cells (e.g., higher preference for pico cells, as compared to macro or micro cells), or a higher preference may be applied based on cell type, e.g., higher preference for pico cells over micro, and micro over macro, for example.

Alternatively, cell preference may be based on cell utilization/load or available resources. For example, a network entity may assign a cell preference to each BS based on the available resources at each BS (or inversely proportional to load or utilization). Thus, for example, a higher priority may be assigned to a BS/cell that is lightly loaded (or most of its resources available), and a lower preference for cells/BSs that are more heavily loaded or less available resources, for example. This may allow, for example, the network to perform load balancing among multiple overlapping cells. For example, each BS may report cell load/utilization or available resources back to a network entity, and then the network entity may send a list of cell preferences for each cell to one or more BSs. Each BS may then broadcast this cell preference information for each of one or more BSs/cells to each of one or more MSs. The MS may then use this preference information in selecting a new preferred BS for idle mode, for example.

A BS may announce or broadcast a signal indicating whether the network is a hierarchical cell structure, e.g., by transmitting an enabled_HCS signal, either 1 or 0, for example (to indicate true or false). In addition, the MS may implicitly learn that the network has a hierarchical cell structure by observing a list of cell preferences transmitted by one or more BS. If HCS is enabled, then the various mechanisms to guide or control the MS selection of a new preferred BS may apply, or may be required (enforced by the BS). Also, in an example embodiment, a field or bit may be set to indicate enforcement of cell priority (or a cell preference) as a global policy for the network. The BS may also choose to enforce the cell priority or cell preference mechanism locally (e.g., per MS) via a capability exchange with each MS, or during a handover message exchange, for example. The MS and BS may exchange capabilities to indicate support for HCS or cell priority, via a capabilities request (SBC-REQ) message indicating whether or not the MS supports these features and/or a capabilities response (SBC-RSP) message from the BS indicating BS support for the HCS and/or cell preference or cell priority features.

In addition, an action or a trigger mechanism may be defined to trigger or cause a MS in idle mode to select (or reselect) a new preferred BS. One or more trigger conditions for cell selection in idle mode may be defined by a network entity or BS, and transmitted or broadcast to MSs. A number of different trigger conditions may be defined or set up, based on a variety of different measurements or criteria. For example, a trigger condition for cell selection may be met when a channel quality (e.g., RSSI or CINR) of a target BS is greater than the channel quality of the current preferred BS by a relative value broadcasted by the preferred BS. This relative value may be used to decrease the amount of switching back and forth between selected BSs, or ping-pong effect. This relative value may also be referred to as a trigger value or a hysteresis margin or threshold.

If there are multiple BSs that meet such criteria, then, for example, the BS having a highest cell preference (e.g., highest cell priority, smallest cell size, or highest available cell resources) may be selected as the new preferred BS for idle mode. Alternatively, the trigger condition may be met when the channel quality of the target BS is greater than a threshold channel quality (or relative value or trigger value) When this occurs, cell selection may be initiated for the target BS for which the trigger condition was met. As described herein, an additional cell selection delay timer may be used in some cases (e.g., where MS is selecting a higher priority cell or higher preference cell) prior to initiating cell selection to the target BS (e.g., making the target BS the new preferred BS).

In addition, according to an example embodiment, one or more neighbor or candidate BSs may be selected (e.g., on the basis of their channel quality compared to the channel quality of the current preferred BS) and added to a list of target BSs that will be monitored for a trigger condition(s). If an idle mode trigger condition occurs or is met for one of the BSs on the list of target BSs being monitored, then the MS may initiate cell reselection, e.g., by selecting the target BS for which an idle mode trigger condition was met to be the new preferred BS for idle mode.

Hysteresis may also be used with a measured channel quality comparison to determine or identify one or more neighbor or candidate BSs to be added to the list of possible target BSs to be monitored for the trigger condition. For example, a neighbor BS may be added to the list of target BSs to be monitored for the trigger condition(s) if the channel quality (e.g., CINR) of the neighbor BS is greater (or larger) than the sum of the channel quality of the current preferred BS and an idle mode hysteresis margin or threshold. If this condition is met, then the neighbor or candidate BS is then added to the list of target BSs that the MS will monitor to determine if a trigger condition(s) is met for one of these target BSs. As noted, if a trigger condition is met for one of the BSs on the list of possible target BSs being monitored, for example, then the MS may initiate cell selection for idle mode (e.g., by the MS selecting the target BS, for which the trigger condition was met, as the new preferred BS for idle mode). The idle mode hysteresis margin may be used to decrease the amount of switching back and forth between selected BSs in the set of target BSs for re-selection.

In addition, a cell selection (or reselection) delay timer may be used in some cases, such as when a MS is moving to (or selecting) a higher preference BS (e.g., where the target BS has a higher cell preference than the current preferred BS). As noted above, larger cells (e.g., lower preference or lower cell priority), such as macro cells are suitable for fast (or faster) moving MSs, since the MS may be able to remain camped to one macro cell for a longer period of time while moving, as compared to a smaller (e.g., micro or pico) cell. Similarly, small or high priority cells/BSs may be unsuitable for a relatively fast moving MS. According to an example embodiment, a cell selection timer may be used to determine the mobility of the MS and discourage or prevent a relative fast moving MS from selecting a high priority or relatively small cell. For example, if a fast moving MS detects a high signal strength or high channel quality from a small/high priority pico cell (e.g., trigger condition is met for the pico cell), then the MS may select the pico cell as a new preferred BS. However, due to its small size, after selecting the pico cell as the new preferred BS and camping on the pico cell (e.g., receiving signals from the pico cell), the MS may quickly detect a loss of signal strength or channel quality from the small/pico cell, which may trigger (as a trigger condition) the MS to select the previous macro cell again or another macro cell as the new preferred BS in idle mode. Thus, at least in some cases, it may be desirable to prevent (or at least decrease the likelihood) that a relatively fast moving MS would select a small or high priority cell/BS as the new preferred BS in idle mode, as this may create instability or a ping-pong effect e.g., where the MS may bounce to the pico cell, and then back to the macro cell in idle mode, according to an example embodiment.

The basic idea behind the cell selection delay timer is that if an MS during idle mode was camped to a low priority cell (e.g., a macro cell) and for a short time it receives a better signal from a high priority cell e.g., a pico cell) it would be better that the MS waits for a specific time or delay period before selecting the high priority cell as the new preferred BS. Once the cell selection delay timer expires, then the signal or channel quality of the pico cell is checked or measured or processed again to determine if the trigger condition is still met. If the trigger condition is still met upon the expiration of the cell selection delay timer, this may mean, for example that the MS is moving slowly or it is not moving at all, thereby allowing the MS to select the pico (or high priority) cell. On the contrary, at timer expiration, due to the high speed of the MS, the signal from a higher priority cell e.g., pico cell) is no longer preferable (e.g., trigger condition is no longer met for the pico cell, as compared to current preferred BS), and the MS continues to be camped on the lower priority cell (macro cell). Therefore, via the use of the cell selection delay timer, unnecessary cell reselection between macro, pico and macro base stations again may be avoided.

A few examples will be briefly described.

Current preferred BS: BS0 (macro cell): HCS_prio for Idle Mode=1 (low priority)

Target Cell List:

BS1 (macro cell): HCS_prio for Idle Mode=1 (low priority)

BS2 (macro cell): HCS_prio for Idle Mode=1 (low priority)

BS3 (micro cell): HCS_prio for Idle Mode=4 (high priority)

### Example 1

### Enabled_HCS=TRUE

Trigger condition for BS1 is met: RSSI(BS1)>Trigger Value for a time interval equal to “Trigger averaging duration”
Δ HCS is calculated to determine if the MS is selecting a new preferred BS that is higher or lower in priority than the current preferred BS. The value of Δ HCS indicates whether the cell selection delay timer will be used. Alternatively the MS may just compare the priority directly and select a new preferred BS with the cell priority higher or lower than the current preferred BS.
In this example 1), Δ HCS=HCS_prio for Idle Mode(BS1)−HCS_prio for Idle Mode(BS0)≦0. This means that the cell priority of target BS is the same or a lower priority as the cell priority of the current preferred BS. Thus, re-selection is triggered toward BS1, without use of cell selection delay timer (BS1 is selected as a new preferred BS for idle mode).

### Example 2

### Enabled_HCS=TRUE

Trigger condition for BS3 is met: RSSI(BS3)>Trigger Value for a time interval equal to “Trigger averaging duration”
Δ HCS=HCS_prio for Idle Mode(BS3)−HCS_prio for Idle Mode(BS0)>0. Thus, the positive Δ HCS value indicates that the new target BS (BS3) has a higher cell priority, e.g., is smaller than current preferred cell/BS (BS0). Thus, when moving to a higher priority or smaller cell (as the new preferred BS), the cell selection delay timer should be used to confirm that the trigger condition is still met upon expiration of the cell selection delay timer.
e.g., start “cell selection delay timer”; when timer expires, if trigger condition is still met for BS3, then cell selection (or reselection) for idle mode is triggered to BS3 (BS3 is selected as a new preferred BS for idle mode).

### Example 3

Enabled HCS=FALSE—this means that hierarchical cell structure or layered network is not used for this network. Thus, in such case, for example, trigger conditions may still be checked to determine when to perform cell selection, but the cell preference or cell priority for different cells and cell selection delay timer are not applied since the cells do not have different priorities or cell types or different cell preferences. Thus, in such case, cell selection (or reselection) is triggered or caused whenever a trigger condition for cell selection in idle mode is met or satisfied.

At MS idle mode initiation, an MS may engage in cell selection (or reselection) to obtain a new preferred BS. A preferred BS is a BS that the MS evaluates and selects as the BS with, e.g., the best air interface DL properties which may include the RSSI, CINR, cell type and the available radio resources, etc.

If enabled_HCS for idle mode is false the MS should trigger cell reselection in case a target BS fulfills trigger conditions for cell reselection. For example, a trigger condition for cell selection may be met when a channel quality (e.g., RSSI or CINR) of a target BS is greater than the channel quality of the current preferred BS by a relative value (or trigger value or margin or threshold) broadcasted by the preferred BS for a time interval equal to Trigger averaging duration. In addition, in case enabled_HCS for idle mode is true, and a target BS meets trigger conditions for cell selections, the MS, before triggering cell reselection to the target BS, should check if either of the following conditions is valid:
1) Cell priority for the target BS is not higher than the current preferred BS; or
2) If Cell priority for that target BS is higher than the current preferred BS (or serving BS or SBS), and a trigger condition for target BS is met before or around the start of “cell selection delay timer” (e.g., which may be started at or soon after the first instance of fulfilled trigger condition) and the trigger condition for target BS is still met or satisfied once “cell re-selection delay timer” expires.
   Re-Selection is triggered toward to target BS

TABLE 1
DCD channel encoding

| | Type | | | PHY |
|---|---|---|---|---|
| Name | (1 byte) | Length | Value (variable length) | Scope |
| Hysteresis | 51 | 1 | Hysteresis margin for HO is | All |
| margin for HO | | | used by the MS to include a neighbor | |
| | | | BS to a list of possible target BSs. | |
| | | | When the CINR of a neighbor BS is | |
| | | | larger than the sum of the CINR of | |
| | | | the current serving BS and the | |
| | | | hysteresis margin for the HO time-to- | |
| | | | trigger duration, then the neighbor BS | |
| | | | is included in the list of possible | |
| | | | target BSs in MOB_MSHO-REQ. It | |
| | | | is the unit of dB and applicable for | |
| | | | only HHO. | |
| Hysteresis | 63 | 1 | Hysteresis margin for cell re- | All |
| margin for Cell re- | | | selection is used by the MS to include | |
| selection in idle | | | a neighbor BS to a list of possible | |
| mode | | | target BSs for re-selection. When the | |
| | | | CINR of a neighbor BS is larger than | |
| | | | the sum of the CINR of the current | |
| | | | serving BS and the hysteresis margin | |
| | | | for the time-to-trigger duration for | |
| | | | cell reselection, then the neighbor BS | |
| | | | is included in the set of preferred BSs | |
| | | | for re-selection. | |
| Time-to- | 52 | 1 | Time-to-Trigger duration for | All |
| Trigger duration for | | | handover is the time duration for MS | |
| Handover | | | decides to select a neighbor BS as a | |
| | | | possible target BS for handover. It is | |
| | | | the unit of ms and applicable only for | |
| | | | HHO. | |
| Time-to- | 67 | 1 | Time-to-Trigger duration for | All |
| Trigger duration for | | | cell re-selection is the time duration | |
| cell reselection | | | for MS decides to select a neighbor | |
| | | | BS as a possible target BS for cell | |
| | | | reselection. It is the unit of ms. | |
| cell re- | 64 | 1 | This is the time expressed in | All |
| selection delay | | | ms, that the MS should wait before | |
| timer | | | starting cell reselection to a | |
| | | | designated target BS (TBS), to be | |
| | | | used only in case the last SBS | |
| | | | (current preferred BS) has priority | |
| | | | lower than the designated TBS and | |
| | | | trigger condition for starting cell re- | |
| | | | selection for the TBS is satisfied. | |
| Enable_HCS | 65 | 1 | Enable_HCS for Idle Mode is | All |
| for idle mode | | | used to indicate to the MS whether | |
| | | | HCS is enabled or disabled. | |
| | | | 0: HCS disabled; | |
| | | | 1: HCS enabled. | |
| HCS_prio | 66 | variable | This is a compound TLV | All |
| for idle mode | | | (field - including type, length and | |
| | | | value) value that defines priority | |
| | | | level assigned to the preferred BS | |
| | | | within the Hierarchical Cell | |
| | | | Structure. | |

TABLE 2
Cell priority for idle mode TLV
description - Trigger; Type/function/action description
The description for cell priority for idle mode is provided below

| Name | Type | Length | Value |
|---|---|---|---|
| N_NEIGHBORS | 66.1 | 1 | |
| | | byte | |
| For (j=0 ; | — | — | — |
| j<N_NEIGHBORS ; | | | |
| j++) { | | | |
| Neighbor | 66.2 | 3 | The least significant 24 bits |
| BSID | | bytes | of the Base Station ID |
| | | | parameter in the DL-MAP |
| | | | message of the Neighbor BS. |
| HCS_prio | 66.3 | 3 | defines priority level |
| for Idle Mode | | bits | (0-7) assigned to the neighbour |
| | | | logical BSs within the |
| | | | Hierarchical Cell Structure. |
| | | | HCS priority level 0 means |
| | | | lowest priority and HCS priority |
| | | | level 7 means highest priority. |
| } | — | — | — |

TABLE 3
Trigger; Type function/action description

| | Length | |
|---|---|---|
| Name | (bit) | Value (variable length) |
| Type | 2 (MSB) | Trigger metric type: |
| | | 0x0: CINR metric |
| | | 0x1: RSSI metric |
| | | 0x2: RTD metric |
| | | 0x3: Reserved |
| | | Note 0x2 is not applicable when action is |
| | | 0x4: cell reselection |
| Function | 3 bits | Computation defining trigger condition: |
| | | 0x0: Reserved |
| | | 0x1: Metric is greater than absolute value |
| | | 0x2: Metric is less than absolute value |
| | | 0x3: Metric of neighbour BS is greater than |
| | | serving BS metric by relative value |
| | | 0x4: Metric of neighbour BS is less than |
| | | serving BS metric by relative value |
| | | 0x5: Metric of serving BS greater than |
| | | absolute value 0x6: Metric of serving BS less than |
| | | absolute value |
| | | 0x7: Reserved |
| | | NOTE-0x1-0x4 not applicable for RTD trigger metric |
| | | NOTE-When type 0x1 is used together with function 0x3 or |
| | | 0x4, the threshold value shall range from −32 dB (0x80) to +31.75 dB |
| | | (0x7F). When type 0x1 is used together with function 0x1, 0x2, 0x5 or |
| | | 0x6, the threshold value shall be interpreted as an unsigned byte with |
| | | units of 0.25 dB, such that 0x00 is interpreted as −103.75 dBm and |
| | | 0xFF is inter-preted as −40 dBm |
| Action | 3 bits | Action performed upon reaching trigger |
| | (LSB) | condition: |
| | | 0x0: Reserved |
| | | 0x1: Respond on trigger with MOB_SCN- |
| | | REP after the end of each scanning interval |
| | | 0x2: Respond on trigger with |
| | | MOB_MSHO-REQ |
| | | 0x3: MS shall start neighbour BS scanning |
| | | process by sending MOB_SCN-REQ, by initiating |
| | | Autonomous neighbour cell scanning (see 8.4.13.1.3) |
| | | or both. |
| | | 0x4: start cell re-selection in Idle Mode |
| | | 0x5-0x7: Reserved |
| | | NOTE-0x3 is not applicable when |
| | | neighbour BS metrices are defined (i.e., only |
| | | Function values 0x5 or 0x6 are applicable). |
| | | Note: Action 0x4 is specific for MSs |
| | | (terminals) in Idle Mode |

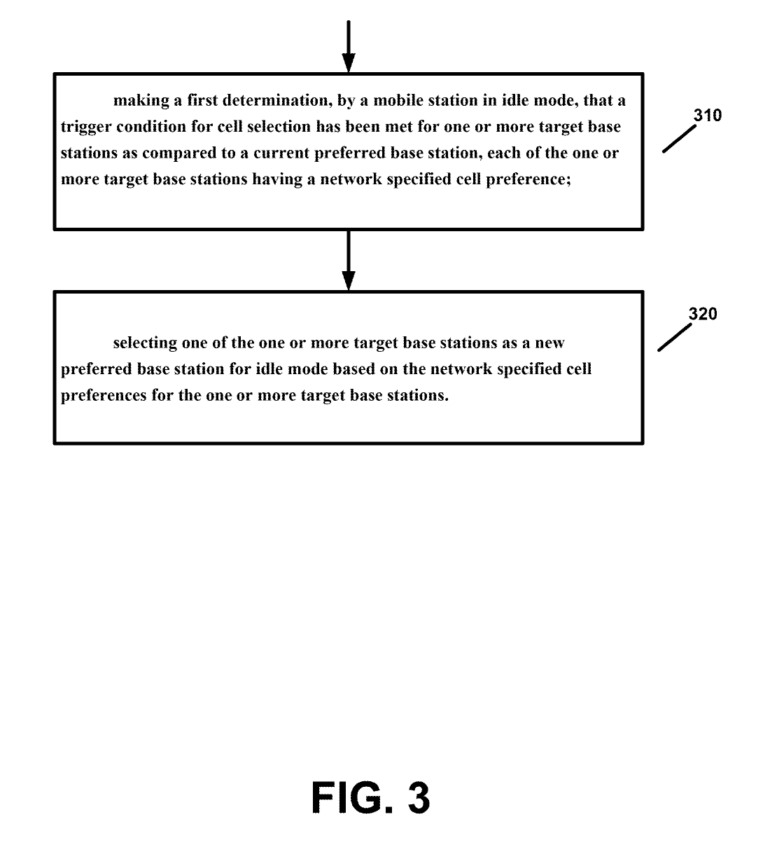

FIG. 3 is a flow chart illustrating operation of a mobile station according to an example embodiment. Operation 30 may include making a first determination, by a mobile station in idle mode, that a trigger condition for cell selection has been met for one or more target base stations as compared to a current preferred base station, each of the one or more target base stations having a network specified cell preference. Operation 320 may include selecting one of the one or more target base stations as a new preferred base station for idle mode based on the network specified cell preferences for the one or more target base stations.

The flow chart of FIG. 3 may further include receiving a message indicating the network specified cell preference for each of a plurality of base stations including the one or more target base stations.

In the flow chart of FIG. 3, operation 320 may include selecting the target base station having a highest network specified cell preference to be the new preferred base station for idle mode.

In the flow chart of FIG. 3, the network specified cell preference comprises one or more of the following: a cell type; a cell size; a cell priority; a cell subscriber group; and/or a cell utilization or cell load.

In the flow chart of FIG. 3, operation 320 may include performing at least one of the following: selecting the target base station having a highest cell priority to be the new preferred base station for idle mode; selecting the target base station having a smallest cell size to be the new preferred base station for idle mode; selecting the target base station that allows access to the same subscriber group; and/or selecting the target base station having a lowest cell utilization or lowest cell load to be the new preferred base station for idle mode.

In the flow chart of FIG. 3, operation 310 may include: comparing a channel quality of the current preferred base station to a channel quality of one or more of the target base stations; and, making a determination that the channel quality of each of the one or more target base stations is greater than the channel quality of the current preferred base station.

In the flow chart of FIG. 3, operation 310 may include comparing a channel quality of the current preferred base station to a channel quality of one or more of the target base stations; and, making a determination that the channel quality of each of the one or more target base stations is greater than the channel quality of the current preferred base station plus a threshold value.

In the flow chart of FIG. 3, the cell preference of the new preferred base station is the same or lower than the cell preference of the current preferred base station.

In the flow chart of FIG. 3, each of the target base stations is associated with one of a plurality of cell types included within a hierarchical cell structure.

In the flow chart of FIG. 3, within a hierarchical cell structure, each of the one or more target base stations is associated with a network specified cell preference(s).

An apparatus may include a processor. The processor may be configured to: make a first determination, by a mobile station in idle mode, that a trigger condition for cell selection has been met for one or more target base stations as compared to a current preferred base station, each of the one or more target base stations having a network specified cell preference; and select one of the one or more target base stations as a new preferred base station for idle mode based on the network specified cell preferences for the one or more target base stations.

In an example embodiment, the processor may include a baseband processor. The apparatus may further include a memory; and a wireless transceiver.

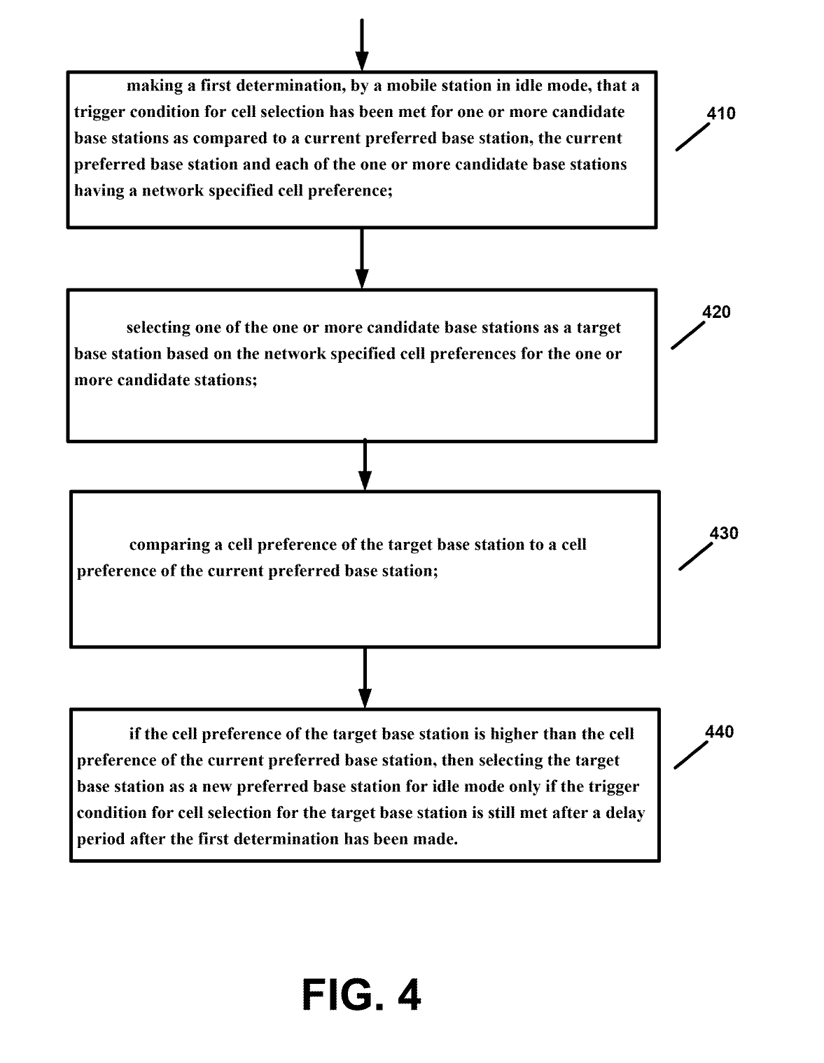

FIG. 4 is a flow chart illustrating operation of a mobile station according to an example embodiment. Operation 410 may include making a first determination, by a mobile station in idle mode, that a trigger condition for cell selection has been met for one or more candidate base stations as compared to a current preferred base station, the current preferred base station and each of the one or more candidate base stations having a network specified cell preference. Operation 420 may include selecting one of the one or more candidate base stations as a target base station based on the network specified cell preferences for the one or more candidate stations. Operation 430 may include comparing a cell preference of the target base station to a cell preference of the current preferred base station. At operation 440, if the cell preference of the target base station is higher than the cell preference of the current preferred base station, then selecting the target base station as a new preferred base station for idle mode only if the trigger condition for cell selection for the target base station is still met after a delay period after the first determination has been made.

In an example embodiment, operation 420 may include selecting one of the one or more candidate base stations that has a highest network specified cell preference as a target base station.

In an example embodiment of the flow chart of FIG. 4, the cell preference may include a network specified cell priority, wherein the selecting comprises selecting one of the one or more candidate base stations that has a highest network specified cell priority as a target base station.

In an example embodiment of the flow chart of FIG. 4, the cell preference may include a network specified cell size, wherein the selecting comprises selecting one of the one or more candidate base stations that has a smallest network specified cell size as a target base station.

In an example embodiment of the flow chart of FIG. 4, the cell preference may include a cell subscriber group, wherein the selecting comprises selecting one of the one or more candidate base stations that has a specific subscriber group or that matches the cell subscriber group of the current preferred base station.

In an example embodiment of the flow chart of FIG. 4, the cell preference may include a network specified cell utilization or cell load, wherein the selecting comprises selecting one of the one or more candidate base stations that has a lowest cell utilization or cell load as a target base station.

In an example embodiment of the flow chart of FIG. 4 may further include: otherwise, if the cell preference of the target base station is not higher than the cell preference of the serving base station, then selecting the target base station as a new preferred base station for idle mode.

In an example embodiment of the flow chart of FIG. 4 may further include: if the trigger condition for cell selection is not still met after a delay period after the first determination has been made, then remaining with the serving base station.

In an example embodiment of the flow chart of FIG. 4, the network specified cell preference may include one or more of the following: cell type; cell size; cell priority; and/or cell utilization or cell load.

In an example embodiment of the flow chart of FIG. 4, the operation 430 may include at least one of: comparing a cell type of the target base station to a cell type of the current preferred base station; comparing a cell size of the target base station to a cell size of the current preferred base station; comparing a cell priority of the target base station to a cell priority of the current preferred base station; comparing a cell subscriber group of the target base station to a cell subscriber group of the current preferred base station; and/or comparing a cell utilization or load of the target base station to a cell utilization or load of the current preferred base station.

In an example embodiment of the flow chart of FIG. 4, the operation 420 may include: initializing a cell selection delay timer to a delay period when the first determination is made; determining whether or not the trigger condition for cell selection for the target base station is still met upon expiration of the cell selection delay timer; and, if the cell preference of the target base station is higher than the cell preference of the current preferred base station, then selecting the target base station as a new preferred base station for idle mode only if the trigger condition for cell selection for the target base station is still met upon expiration of the cell selection delay timer.

According to another example embodiment, an apparatus may include a processor. The processor may be configured to: make a first determination, by a mobile station in idle mode, that a trigger condition for cell selection has been met for one or more candidate base stations as compared to a current preferred base station, the current preferred base station and each of the one or more candidate base stations having a network specified cell preference; select one of the one or more candidate base stations as a target base station based on the network specified cell preferences for the one or more candidate stations; compare a cell preference of the target base station to a cell preference of the current preferred base station; and if the cell preference of the target base station is higher than the cell preference of the current preferred base station, then selecting the target base station as a new preferred base station for idle mode only if the trigger condition for cell selection for the target base station is still met after a delay period after the first determination has been made.

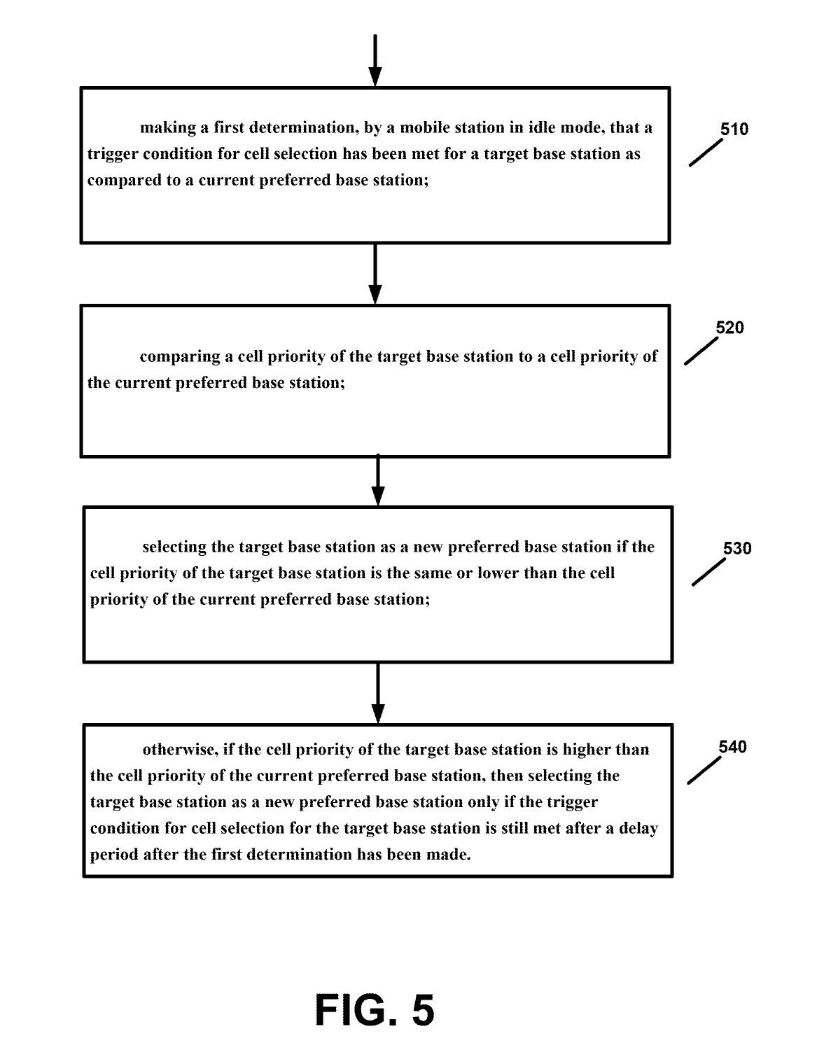

FIG. 5 is a flow chart illustrating operation of a mobile station according to an example embodiment. Operation 510 may include making a first determination, by a mobile station in idle mode, that a trigger condition for cell selection has been met for a target base station as compared to a current preferred base station. Operation 520 may include comparing a cell priority of the target base station to a cell priority of the current preferred base station. Operation 530 may include selecting the target base station as a new preferred base station if the cell priority of the target base station is the same or lower than the cell priority of the current preferred base station. Operation 540 may include, otherwise, if the cell priority of the target base station is higher than the cell priority of the current preferred base station, then selecting the target base station as a new preferred base station only if the trigger condition for cell selection for the target base station is still met after a delay period after the first determination has been made.

In the flow chart of FIG. 5, the operation 510 may include comparing a channel quality of the current preferred base station to a channel quality of the target base station; and, making a determination that the channel quality of the target base station is greater than the channel quality of the current preferred base station.

In the flow chart of FIG. 5, the operation 510 may include comparing a channel quality of the current preferred base station to a channel quality of the target base station; and, making a determination that the channel quality of the target base station is greater than the channel quality of the current preferred base station plus a threshold value.

According to an example embodiment, the flow chart of FIG. 5 may further include receiving at the mobile station a message indicating a cell priority for a plurality of base stations, including a cell priority of the current preferred base station and a cell priority of the target base station.

According to an example embodiment, the flow chart of FIG. 5 may further include receiving at the mobile station from the current preferred base station a message indicating a cell type for each of a plurality of base stations, including a cell type of the current preferred base station and a cell type of the target base station, each cell type being associated with a cell priority.

In the flow chart of FIG. 5, the channel quality may include one of a carrier to interference and noise ratio (CINR) of a received signal or a received signal strength indication (RSSI) of a received signal, as measured by the mobile station.

According to an example embodiment, the flow chart of FIG. 5 may further include the mobile station exiting idle mode and performing network re-entry with the new preferred base station.

In the flow chart of FIG. 5, operation 530 may include initializing a cell selection delay timer to a delay period when the first determination is made; determining whether or not the trigger condition for cell selection is still met upon expiration of the cell selection delay timer; and if the cell priority of the target base station is higher than the cell priority of the serving base station, then selecting the target base station as a new preferred base station only if the trigger condition for cell selection for the target base station is still met upon expiration of the cell selection delay timer.

In the flow chart of FIG. 5, operation 520 may include comparing a cell type of the target base station to a cell type of the current preferred base station, each cell type being associated with a cell priority.

According to another example embodiment, an apparatus may include a processor. The processor may be configured to: make a first determination, by a mobile station in idle mode, that a trigger condition for cell selection has been met for a target base station as compared to a current preferred base station; compare a cell priority of the target base station to a cell priority of the current preferred base station; select the target base station as a new preferred base station if the cell priority of the target base station is the same or lower than the cell priority of the current preferred base station; and, otherwise, if the cell priority of the target base station is higher than the cell priority of the current preferred base station, then selecting the target base station as a new preferred base station only if the trigger condition for cell selection for the target base station is still met after a delay period after the first determination has been made.

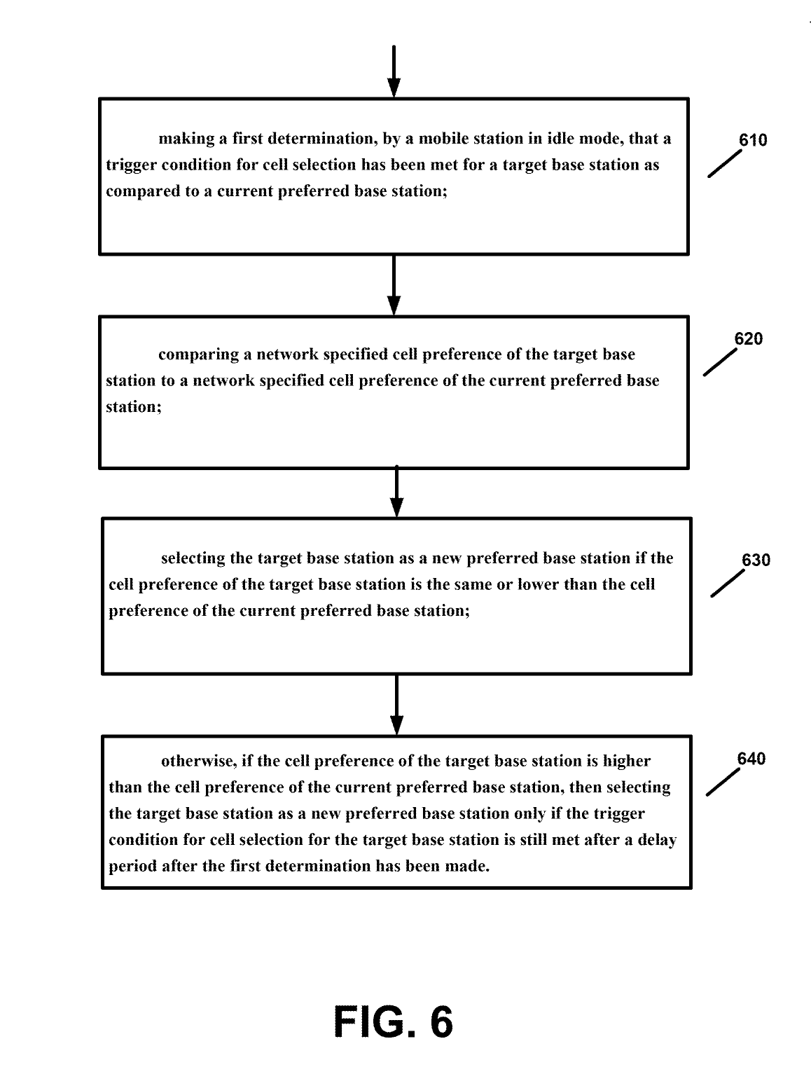

FIG. 6 is a flow chart illustrating operation of a mobile station according to an example embodiment. Operation 610 may include making a first determination, by a mobile station in idle mode, that a trigger condition for cell selection has been met for a target base station as compared to a current preferred base station. Operation 620 may include comparing a network specified cell preference of the target base station to a network specified cell preference of the current preferred base station. Operation 630 may include selecting the target base station as a new preferred base station if the cell preference of the target base station is the same or lower than the cell preference of the current preferred base station. Operation 640 may include otherwise, if the cell preference of the target base station is higher than the cell preference of the current preferred base station, then selecting the target base station as a new preferred base station only if the trigger condition for cell selection for the target base station is still met after a delay period after the first determination has been made.

In the flow chart of FIG. 6, the network specified cell preference may include one or more of the following: cell type; cell size; cell priority; a cell subscriber group; and/or cell utilization or cell load, or available resources.

According to another example embodiment, an apparatus may include a processor. The processor may be configured to: make a first determination, by a mobile station in idle mode, that a trigger condition for cell selection has been met for a target base station as compared to a current preferred base station; compare a network specified cell preference of the target base station to a network specified cell preference of the current preferred base station; select the target base station as a new preferred base station if the cell preference of the target base station is the same or lower than the cell preference of the current preferred base station; otherwise, if the cell preference of the target base station is higher than the cell preference of the current preferred base station, then selecting the target base station as a new preferred base station only if the trigger condition for cell selection for the target base station is still met after a delay period after the first determination has been made.

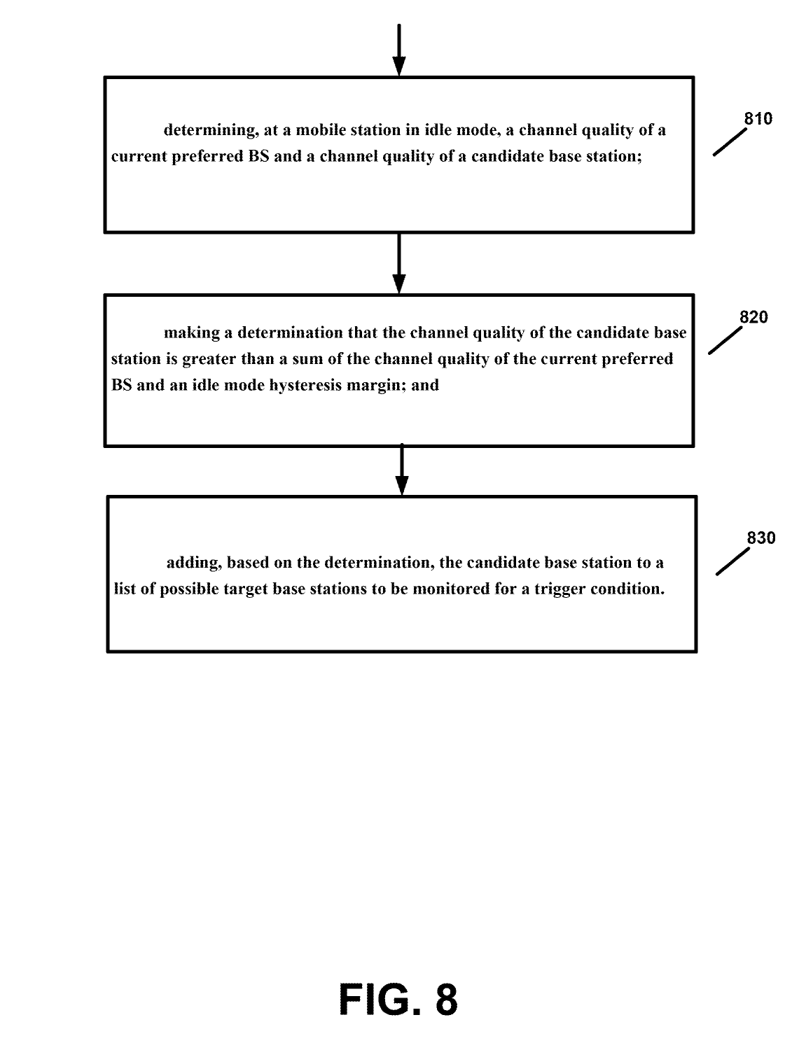

FIG. 8 is a flow chart illustrating operation of a mobile station according to another example embodiment. Operation 810 may include determining, at a mobile station in idle mode, a channel quality of a current preferred BS and a channel quality of a candidate base station. Operation 820 may include making a determination that the channel quality of the candidate base station is greater than a sum of the channel quality of the current preferred BS and an idle mode hysteresis margin. And, operation 830 may include adding, based on the determination, the candidate base station to a list of possible target base stations to be monitored for a trigger condition.

The flow chart of FIG. 8 may further include determining, by the mobile station, that a trigger condition for cell reselection in idle mode has been met for one of the base stations on the list of target base stations; and selecting the base station for which the trigger condition has been met as a new preferred base station for idle mode.

The flow chart of FIG. 8 may further include determining, by the mobile station, that a trigger condition for cell reselection in idle mode has been met for one or more of the base stations on the list of target base stations; and selecting, based on one or more network specified cell preferences provided for one or more of the base stations, one of the one or more base stations for which the trigger condition has been met to be a new preferred base station for idle mode.

The flow chart of FIG. 8 may further include determining, by the mobile station, that a trigger condition for cell reselection in idle mode has been met for one or more of the base stations on the list of target base stations; and selecting one of the one or more base stations for which the trigger condition has been met that has a highest cell priority, among the base stations for which the trigger condition was met, to be a new preferred base station for idle mode.

The flow chart of FIG. 8 may further include making a first determination, by a mobile station in idle mode, that a trigger condition for cell selection has been met for one or more of the target base stations on the list of target base stations, each of the one or more target base stations having a network specified cell preference; selecting, as a target base station, one of the one or more base stations for which a trigger condition has been met based on a network specified cell preference for one or more of the base stations; comparing a cell preference of the target base station to a cell preference of the current preferred base station; and, if the cell preference of the target base station is higher than the cell preference of the current preferred base station, then selecting the target base station as a new preferred base station for idle mode only if the trigger condition for cell selection for the target base station is still met after a delay period after the first determination has been made.

In the flow chart of FIG. 8 the network specified cell preference may include one or more of the following: cell type; cell size; cell priority; and/or cell utilization or cell load.

The flow chart of FIG. 8 may further include making a first determination, by a mobile station in idle mode, that a trigger condition for cell selection has been met for one or more of the target base stations on the list of target base stations, each of the one or more target base stations having a network specified cell priority; selecting, as a target base station, one of the one or more base stations for which a trigger condition has been met based on a network specified cell priority for one or more of the base stations; comparing a cell priority of the target base station to a cell priority of the current preferred base station; and, if the cell priority of the target base station is higher than the cell priority of the current preferred base station, then selecting the target base station as a new preferred base station for idle mode only if the trigger condition for cell selection for the target base station is still met after a delay period after the first determination has been made.

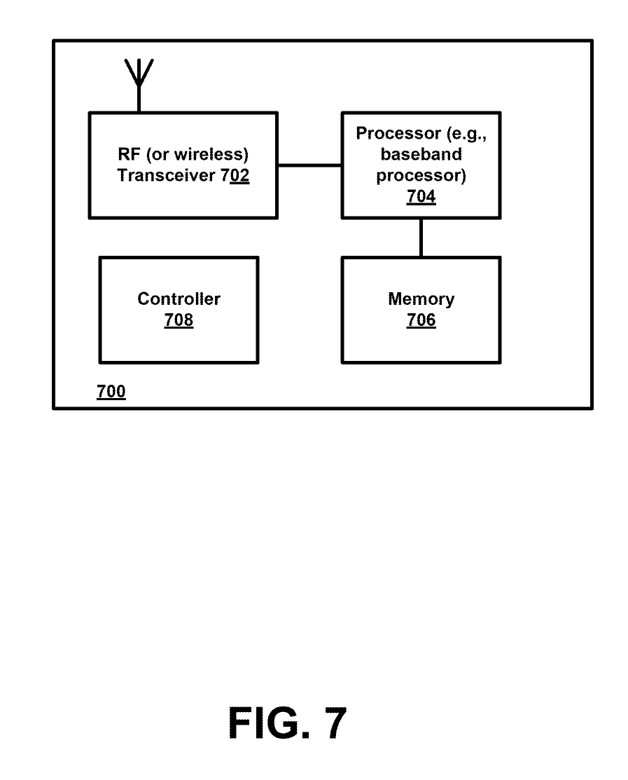

FIG. 7 is a block diagram of a wireless station (or wireless node) 700 according to an example embodiment. The wireless station 700 (e.g., base station 104 or mobile station 106) may include, for example, an RF (radio frequency) or wireless transceiver 702, including a transmitter to transmit signals and a receiver to receive signals, a processor 704 to execute instructions or software and control transmission and receptions of signals, and a memory 706 to store data and/or instructions.

Processor 704 may also make decisions or determinations, generate frames or messages for transmission, decode received frames or messages for further processing, and other tasks or functions described herein. Processor 704, which may be a baseband processor, for example, may generate messages, packets, frames or other signals for transmission via wireless transceiver 702. Processor 704 may control transmission of signals or messages over a wireless network, and may receive signals or messages, etc., via a wireless network (e.g., after being down-converted by wireless transceiver 702, for example). Processor 704 may be programmable and capable of executing software or other instructions stored in memory or on other computer media to perform the various tasks and functions described above, such as one or more of the tasks or methods described above. Processor 704 may be (or may include), for example, hardware, programmable logic, a programmable processor that executes software or firmware, and/or any combination of these. Using other terminology, processor 704 and transceiver 702 together may be considered as a wireless transmitter/receiver system, for example.

In addition, referring to FIG. 7, a controller (or processor) 708 may execute software and instructions, and may provide overall control for the station 700, and may provide control for other systems not shown in FIG. 7, such as controlling input/output devices (e.g., display, keypad), and/or may execute software for one or more applications that may be provided on wireless station 700, such as, for example, an email program, audio/video applications, a word processor, a Voice over IP application, or other application or software.

In addition, a storage medium may be provided that includes stored instructions, which when executed by a controller or processor may result in the processor 704, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. A method comprising:
making a first determination, by a mobile station in idle mode, that a trigger condition for cell selection has been met for one or more target base stations as compared to a current preferred base station, each of the one or more target base stations having a network specified cell preference;
selecting one of the one or more target base stations as a new preferred base station for idle mode based on the network specified cell preferences for the one or more target base stations.

2. The method of claim 1 and further comprising:
receiving a message indicating the network specified cell preference for each of a plurality of base stations including the one or more target base stations.

3. The method of claim 1 wherein the selecting comprises selecting the target base station having a highest network specified cell preference to be the new preferred base station for idle mode.

4. The method of claim 1 wherein the network specified cell preference comprises one or more of the following:
a cell type;
a cell size;
a cell priority;
a cell subscriber group; and/or
a cell utilization or cell load.

5. The method of claim 1 wherein the selecting comprises performing at least one of the following:
selecting the target base station having a highest cell priority to be the new preferred base station for idle mode;
selecting the target base station having a smallest cell size to be the new preferred base station for idle mode;
selecting the target base station that allows access to the same subscriber group; and/or
selecting the target base station having a lowest cell utilization or lowest cell load to be the new preferred base station for idle mode.

6. The method of claim 1 wherein the making a first determination comprises:
comparing a channel quality of the current preferred base station to a channel quality of one or more of the target base stations;
making a determination that the channel quality one or more target base stations is greater than the channel quality of the current preferred base station plus a threshold value (e.g., relative value or trigger value).

7. The method of claim 1 wherein the making a first determination comprises:
comparing a channel quality of the current preferred base station to a channel quality of one or more of the target base stations;
making a determination that the channel quality of one or more target base stations is greater than the channel quality of the current preferred base station plus a threshold value.

8. The method of claim 1 wherein the cell preference of the new preferred base station is the same or lower than the cell preference of the current preferred base station.

9. The method of claim 1 wherein each of the target base stations is associated with one of a plurality of cell types included within a hierarchical cell structure.

10. The method of claim 1 wherein, within a hierarchical cell structure, each of the one or more target base stations is associated with a network specified cell preference(s).

11. An apparatus comprising:
a processor, the processor configured to:
make a first determination, by a mobile station in idle mode, that a trigger condition for cell selection has been met for one or more target base stations as compared to a current preferred base station, each of the one or more target base stations having a network specified cell preference;
select one of the one or more target base stations as a new preferred base station for idle mode based on the network specified cell preferences for the one or more target base stations.

12. The apparatus of claim 11 wherein the processor comprises a baseband processor.

13. The apparatus of claim 11 and further comprising:
a memory; and
a wireless transceiver.

14-38. (canceled)

39. A method comprising:
determining, at a mobile station in idle mode, a channel quality of a current preferred BS and a channel quality of a candidate base station;
making a determination that the channel quality of the candidate base station is greater than a sum of the channel quality of the current preferred BS and an idle mode hysteresis margin; and
adding, based on the determination, the candidate base station to a list of possible target base stations to be monitored for a trigger condition.

40. The method of claim 39 and further comprising:
determining, by the mobile station, that a trigger condition for cell reselection in idle mode has been met for one of the base stations on the list of target base stations; and
selecting the base station for which the trigger condition has been met as a new preferred base station for idle mode.

41. The method of claim 39 and further comprising:
determining, by the mobile station, that a trigger condition for cell reselection in idle mode has been met for one or more of the base stations on the list of target base stations; and
selecting, based on one or more network specified cell preferences provided for one or more of the base stations, one of the one or more base stations for which the trigger condition has been met to be a new preferred base station for idle mode.

42. The method of claim 39 and further comprising:
determining, by the mobile station, that a trigger condition for cell reselection in idle mode has been met for one or more of the base stations on the list of target base stations; and
selecting one of the one or more base stations for which the trigger condition has been met that has a highest cell priority, among the base stations for which the trigger condition was met, to be a new preferred base station for idle mode.

43. The method of claim 39 and further comprising:
making a first determination, by a mobile station in idle mode, that a trigger condition for cell selection has been met for one or more of the target base stations on the list of target base stations, each of the one or more target base stations having a network specified cell preference;
selecting, as a target base station, one of the one or more base stations for which a trigger condition has been met based on a network specified cell preference for one or more of the base stations;
comparing a cell preference of the target base station to a cell preference of the current preferred base station;
if the cell preference of the target base station is higher than the cell preference of the current preferred base station, then selecting the target base station as a new preferred base station for idle mode only if the trigger condition for cell selection for the target base station is still met after a delay period after the first determination has been made.

44. The method of claim 39 wherein the network specified cell preference comprises one or more of the following:
cell type;
cell size;
cell priority; and/or
cell utilization or cell load.

45. The method of claim 39 and further comprising:
making a first determination, by a mobile station in idle mode, that a trigger condition for cell selection has been met for one or more of the target base stations on the list of target base stations, each of the one or more target base stations having a network specified cell priority;
selecting, as a target base station, one of the one or more base stations for which a trigger condition has been met based on a network specified cell priority for one or more of the base stations;
comparing a cell priority of the target base station to a cell priority of the current preferred base station;
if the cell priority of the target base station is higher than the cell priority of the current preferred base station, then selecting the target base station as a new preferred base station for idle mode only if the trigger condition for cell selection for the target base station is still met after a delay period after the first determination has been made.
